(19) United States
(12) Patent Application Publication
(10) Pub. No.: US 2014/0125804 A1
(43) Pub. Date: May 8, 2014

(54) MOBILE FILM STUDIO AND SYSTEM

(71) Applicant: Irwin D. Dammers, Buffalo Grove, IL (US)

(72) Inventor: Irwin D. Dammers, Buffalo Grove, IL (US)

(21) Appl. No.: 14/073,070

(22) Filed: Nov. 6, 2013

Related U.S. Application Data
(60) Provisional application No. 61/723,096, filed on Nov. 6, 2012.

(51) Int. Cl. H04N 5/28

(52) U.S. Cl. CPC H04N 5/28
USPC 348/148

(57) ABSTRACT

A device and system to provide a user with a platform from which video and audio productions can be shot, edited and produced to final form is provided. In a preferred embodiment, the device includes a vehicle with a climate controlled cabin and at least one camera, lighting equipment, editing and production equipment. The vehicle further includes platforms for mounting lighting and cameras on the exterior of the vehicle to facilitate filming of scenes. The vehicle allows the remote control of the filming and editing process either from within the vehicle or by users outside of the vehicle, such that finished video can be produced therein. Communications equipment to and from the vehicle is provided and the vehicle is fully mobile so as to facilitate the movement of equipment and people to the site of production.

### CROSS-REFERENCES TO RELATED APPLICATIONS

The present application is a continuation of provisional Application No. 61/723,096; filed on Nov. 6, 2012, the full disclosures of which is incorporated herein by reference.

### FIELD OF THE INVENTION

The present invention relates to a device useful to the motion picture industry and, more particularly, the present invention concerns a mobile video capture and editing studio.

### BACKGROUND OF THE INVENTION

It will be understood that the vocabulary of the industry that this invention is associated with continues to refer to motion pictures as “film” The term “film” as used herein, unless otherwise specified, relates not only to traditional film, but as well to video tape and any other means of capturing and storing video and/or audio, including the playback thereof, either currently in use, contemplated, or as will be developed in the future.

There are currently several types of vehicles that support film production, including: a camera car/truck which is a vehicle that has some sort of mounts on it for cameras, a jib or crane and platforms for camera operators to work from; a grip and electric truck; usually some sort of box truck, cargo van or trailer that transports the lights, extension cords, various clamps, stands, camera supports, scrims, flags, and filters for the lighting equipment and generators all necessary in the production of a motion picture; and a craft service vehicle, which provides food and beverages for the cast and crew. Other things that are needed which often are not available in a vehicle are cameras, tripods, sound recording equipment (including microphones, wired and wireless, cables, boom poles, an audio recorder), and some sort of playback equipment both audio and video so the captured footage can be viewed.

In the past decade as digital forms of recording have improved and equipment has reduced in size the industry as a whole has not embraced the unique ability of this new equipment as it relates to size and the overall compactness of this digital frontier. People in the industry are still rolling out all these past vehicles for the production of a feature film even if it is being captured with this new digital equipment.

Sometimes when a movie is being recorded, a computer is put on a cart and rolled in to whatever shelter is available such as underneath a tent awning or in back of a box truck. A video village, used for watching the footage on monitors, is normally set up in an adjacent room or underneath an awning. These outdoor locations are normally uncomfortable and not well adapted for editing in the field.

Moreover, when scenes are shot, most of the editing process may not commence until after all the shooting has completed and the actors have departed. Therefore, scenes which may require audio dialogue replacement (ADR), or need to be reshot, can add significant cost and time delays to the completion of the film because the actors have to be flown in to provide the ADR or to reshoot the scenes.

Therefore, there is a need for a mobile film studio that enables a movie to be recorded and edited on location. The present invention seeks to combine, in a novel manner with unexpected results, all the aforementioned vehicles and equipment into one cost-saving vehicle. Money will be saved not only in the costs of the vehicle and equipment but in time spent, and in the protection of expensive cameras and editing devices, as well as, with one vehicle comprised of all this technology, there will be a significant reduction in fuel costs thereby also helping the environment.

### SUMMARY OF THE INVENTION

In accordance with the present invention a device and system are provided wherein a finished motion picture can be created. In the preferred embodiment the device comprises a mobile film studio comprising a vehicle, at least one camera, one or more lighting fixtures, editing and production equipment within the vehicle, such that a user may operate the vehicle to produce a movie. In a preferred embodiment, the vehicle includes a climate controlled cabin so as to allow the vehicle to be used in various climates while keeping the persons within comfortable.

In embodiments of the present invention, the vehicle includes roof top mounted camera holders so that filming can be accomplished with various angles of shooting. The roof top mounted camera holders, in some embodiments can be remotely controllable from within the vehicle or from a remote location as desired. In this way a user can control the one or more cameras and edit video from within the vehicle or use the vehicle to do either of these tasks without the other.

It will be seen that the one or more camera associated with the vehicle can be video or film cameras; recording on any media desired. The concomitant editing equipment can be provided such that the vehicle is capable of producing video and audio on any type of media and or providing a streamed video and audio production as desired.

So as to provide the most control of the filming and editing, the one or more light fixtures include lighting assemblies; can be attached to the exterior of the vehicle in a manner known to persons having skill in the art. It will be understood that the lighting fixtures, in a preferred embodiment, will be remotely controllable from within the vehicle. Further, components allowing communication with the vehicle will be included in a preferred embodiment such that the director of the video or audio can be at an advantageous location while the filming is progressing, while still maintaining control of the processes. In a preferred embodiment, the system will include at least one camera and at least one light fixture that are remotely controllable from outside of the vehicle.

In a preferred embodiment, the system for providing a mobile film studio of the present invention will include a vehicle, a climate controlled cabin inside the vehicle, multiple cameras, lighting and editing and production equipment. Further the vehicle will have roof top mounted remote controlled camera slider equipment or jibs wherein a user may operate the lighting, multiple cameras, and editing and production equipment inside the vehicle to produce a movie. It will be understood that one or more of the cameras can be either a video camera or a film camera and that any combination of video and film cameras can be used.

In the preferred embodiment, the lighting includes lighting assemblies attached to the exterior of the vehicle. Including lighting assemblies that can be remotely controllable from within the vehicle or from outside of the vehicle. Components allowing communication with the vehicle will be provided so as to allow control from an external point. Further, the editing and production equipment provided within the vehicle are sufficient to produce a finished video and audio presentation.

A more detailed explanation of the invention is provided in the following description and claims and is illustrated in the accompanying drawings

### BRIEF DESCRIPTION OF THE DRAWINGS

FIG. 1 is a perspective view of the invention.

FIG. 2 is a schematic view of the invention.

FIG. 3 is a detailed perspective view of the invention.

FIG. 4 is a perspective view of an alternate embodiment of the invention.

FIG. 5 is a detailed perspective view of an alternate embodiment of the invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention.

Broadly, an embodiment of the present invention provides a mobile film studio which combines a camera production truck, grip truck, electrical truck, craft service truck and a video village (or playback area) with a fully equipped editing studio. The studio combines all the elements from a film editing suite, sound recording studio and CG (computer generated) design studio into a mobile package. The camera production truck of the present invention also has lighting, grip, electrical equipment, camera support equipment and craft service equipment, as well as professional cameras in one vehicle.

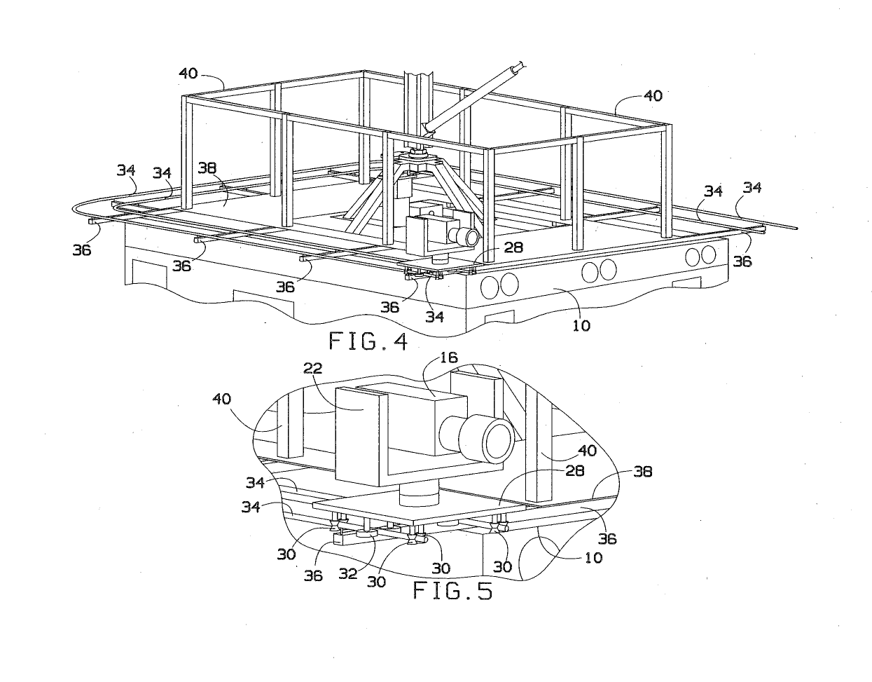

An exemplary embodiment of the mobile film studio combines aspects of post production including full editing and ADR while filming occurs live on location. The mobile studio also includes, but is not limited to, cameras, tripods, dollies, 3k+lighting and grip equipment, camera stabilizing equipment (e.g., Steadicam™), a jib, and a roof mounted crane with at least three separate platform positions for filming from the vehicle. The mobile film studio further includes a unique vehicle-mounted remote controlled camera slider (referenced in FIGS. 4 and 5), for another way of capturing shots with great camera angles.

Referring now to the figures, the studio equipment is preferably integrated into the interior of the vehicle. The interior of the mobile studio may be a climate-controlled environment and may include electrical outlets, a video village, a mobile audio/video recording and editing system, microphones, speakers, computer equipment, camera support, professional cameras, and video monitors among other items/electronics/appliances.

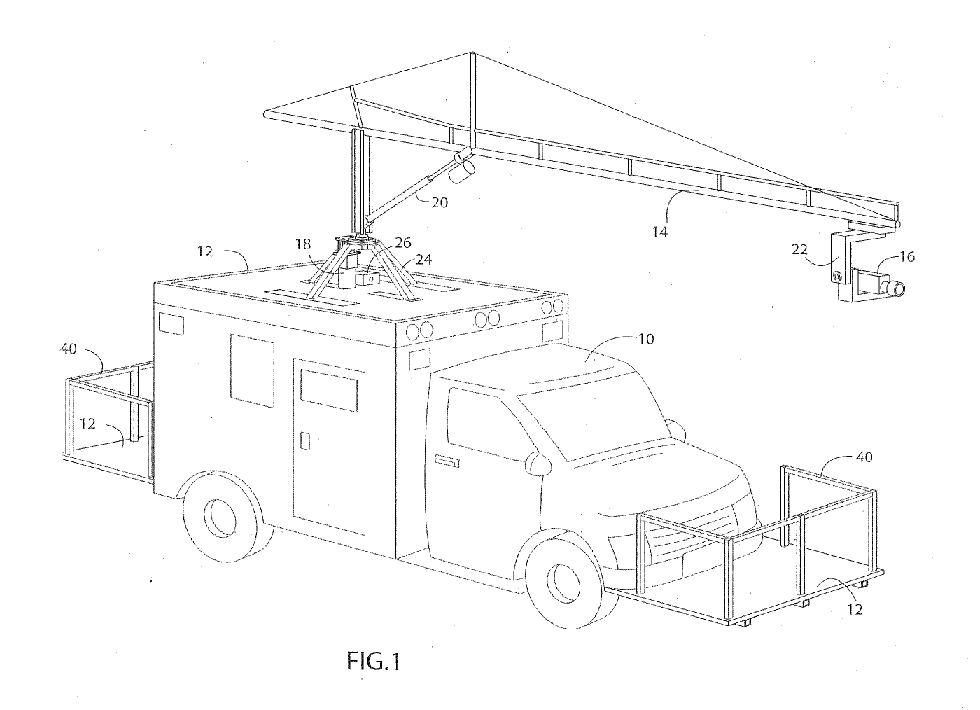

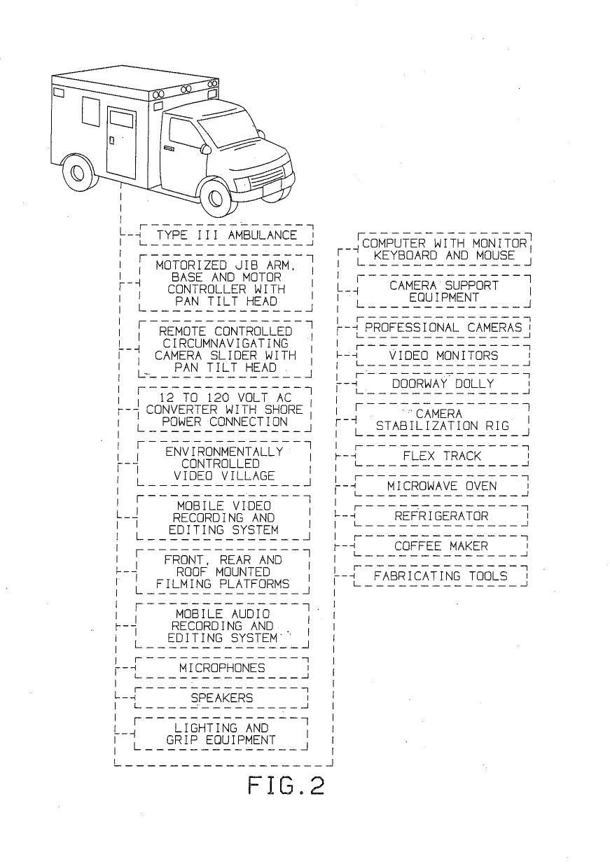

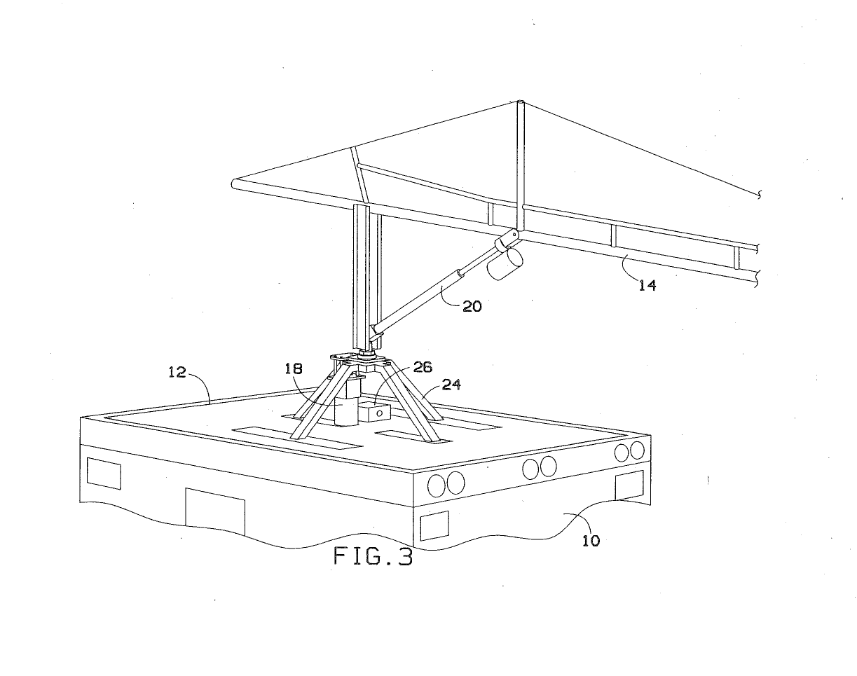

FIG. 1 shows an embodiment of the mobile studio where the studio is equipped to enable filming, recording and editing of recorded audio and video. FIG. 3 shows an embodiment of the roof of the mobile studio, illustrating the use of a jib arm 14. A quad pod 24 may be on the roof or deck plate 38 of the vehicle 10 and is used to mount the jib arm 14, which may be controlled from inside the vehicle 10 using joystick controls, a mouse, or any other form of input device. In an embodiment, the quad pod 24 is customizable so that different types of equipment can be fitted to the quad pod. Wires may travel through the hollowed rod to run between a camera 16 at the end of the jib arm 14 and motors to the interior of the vehicle for controlling and transferring data from the camera 16.

In one embodiment, the mobile studio or specialized vehicle 10 may include filming platforms 12 and a stable roof or deck plate 38 that also feature a motorized jib arm 14. The jib arm 14 is controlled by the jib arm motor 18 and the jib arm linear actuator 20. The mobile studio also includes a wiring junction box 26 for concealing and protecting delicate electrical connections. A video camera 16 may also be connected to the jib arm 14 where a tilt pan head 22 is able to rotate the camera through vertical and/or horizontal planes.

FIGS. 4 and 5 show an embodiment of the roof of the mobile studio, illustrating the use of a video camera 16 on a track 34 that travels around the circumference of the roof using a remote control located in the interior of the vehicle, and a safety barrier 40. The video camera 16 is connected to a camera slider 28 and rolls around a camera track 34 via the camera slider track roller 30 and camera slider drive wheel 32. The camera track 34 is supported by the track support 36. The attachment of the camera 16 to the track 34 enables the camera to pan around the vehicle for optimal recording angles when in use. The mobile studio 10 also features a safety barrier 40 to ensure the safety of any persons using the roof 38. The camera 16 and/or slider 28 may be controlled in the interior of the vehicle 10 by any known input method, including a joystick, mouse, etc.

In the interior of the vehicle, producers, directors and other essential personnel will be able to view multiple cameras while the vehicle is moving or stationary in a climate-controlled atmosphere. The vehicle is also equipped with platforms 12 at the front, rear and roof for cameramen to have access to for filming. Video village no longer needs to be exposed to the environments and the producers can now sit comfortably in our environmentally-controlled mobile room while watching the action going on outside in the heat or the cold.

It should be understood, of course, that the foregoing relates to exemplary embodiments of the invention and that modifications may be made without departing from the spirit and scope of the invention as set forth in the following claims.

What is claimed is:

1. A system for providing a mobile film studio comprising:
a vehicle;
at least one camera;
one or more lighting fixtures;
editing and production equipment within the vehicle;
wherein a user may operate the vehicle to produce a movie.

2. The system of claim 1, wherein the vehicle includes a climate controlled cabin.

3. The system of claim 1, wherein the vehicle includes roof top mounted camera holders.

4. The system of claim 3, wherein the roof top mounted camera holders are remotely controllable from within the vehicle.

5. The system of claim 1 wherein a user can control the one or more cameras and edit video from within the vehicle.

6. The system of claim 1, wherein the one or more camera is a video camera.

7. The system of claim 1, wherein the one or more light fixtures, include lighting assemblies attached to the exterior of the vehicle.

8. The system of claim 7, wherein the lighting fixtures are remotely controllable from within the vehicle.

9. The system of claim 1, including components allowing communication with the vehicle.

10. The system of claim 1, wherein the at least one camera and at least one light fixture of the vehicle are remotely controllable from outside of the vehicle.

11. A system for providing a mobile film studio comprising:
a vehicle;
a climate controlled cabin inside the vehicle;
multiple cameras;
lighting;
and editing and production equipment,
Roof Top Mounted Remote controlled Camera Slider
wherein a user may operate the lighting, multiple cameras, and editing and production equipment inside the vehicle to produce a movie.

12. The system of claim 11, wherein one or more of the cameras is a video camera.

13. The system of claim 11, wherein the lighting, includes lighting assemblies attached to the exterior of the vehicle.

14. The system of claim 13, wherein the lighting assemblies are remotely controllable from within the vehicle.

15. The system of claim 11, including components allowing communication with the vehicle.

16. The system of claim 11, wherein at least one camera and at least one light fixture of the vehicle are remotely controllable from outside of the vehicle.

17. The system of claim 11, wherein at least one camera is a video camera and at least one camera is a film camera.

18. The system of claim 11, wherein the editing and production equipment are sufficient to produce a finished video and audio presentation.
